(19) United States
(12) Patent Application Publication
(10) Pub. No.: US 2007/0063634 A1
(43) Pub. Date: Mar. 22, 2007

(54) Image display

(75) Inventors: Tsuyoshi Oyaizu, Saitama-ken (JP); Hitoshi Tabata, Saitama-ken (JP); Isamu Tsuchiya, Gunma-ken (JP); Takeo Ito, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/556,127

(22) PCT Filed: Apr. 30, 2004
(86) PCT No.: PCT/JP04/05835

§ 371 Date: Nov. 27, 2006

(30) Foreign Application Priority Data
May 9, 2003 (JP) 2003-131476

(51) Int. Cl. H01J 63/04; H01J 1/62

(52) U.S. Cl. 313/496

(57) ABSTRACT

This image display unit includes a face plate (6) on an inner surface of which a phosphor screen is formed, and a rear plate having a large number of electron emission elements, wherein the phosphor screen includes a light absorption layer (8), a phosphor layer (9), a metal back layer (10) having a separating portion (10a) and formed on the phosphor layer, a high-resistance covering layer (11) formed on the separating portion of the metal back layer in such a way as to be laid across the metal back layer of both sides of the separating portion, a heat-resistant fine particle layer (12) formed on the high-resistance covering layer, and a getter layer (13) formed in a film shape above the metal back layer and divided by the heat-resistant fine particle layer. In an image display unit such as an FED, a heat-resistance property is enhanced to prevent destruction or deterioration of the light emission element or the phosphor screen due to an abnormal discharge, so that display of high luminance and high quality can be realized.

### TECHNICAL FIELD

The present invention relates to an image display unit such as a field emission display.

### BACKGROUND ART

Conventionally, in an image display unit such as a cathode-ray tube (CRT) or a field emission display (FED), a metal-backed phosphor screen in which a metal film such as Al is formed on a phosphor layer has been used. This metal film (metal back layer) is intended to enhance luminance by reflecting light which travels toward an electron source side, of light emitted from a phosphor by electrons discharged from an electron source, to a face plate side, and to serve as an anode electrode by supplying the phosphor layer with electric conductivity. The metal film also has a function of preventing the phosphor layer from being damaged by ions generated when gas remaining in a vacuum envelope of the image display unit is ionized

In the FED, since a gap between the face plate having a phosphor screen and a rear plate having an electron emission element is as narrow as from approximately 1 mm to several mm, and a high voltage of approximately 10 kV is applied to this gap to form a high field, an electric field is concentrated in an acute angle part of a peripheral edge portion of the metal back layer, and there has been a case that a discharge (vacuum-arc discharge) occurs. When such an abnormal discharge occurs, a discharge current as large as from several A to several hundred A flows in an instant, and hence there has been a possibility that the electron emission element at a cathode portion or the phosphor screen at an anode portion is destroyed or damaged.

Conventionally, for the purpose of enhancing a withstand voltage property, and in order to reduce damage at a time of occurrence of the discharge, it has been performed that the metal back layer being a conductive film is divided into several blocks and that a gap is provided in a boundary portion (hereinafter referred to as a separating portion) for example, see Patent Document 1).

Recently, in a flat type image display unit, it is studied to form a layer of a getter material in an image display region in order to absorb gas discharged from an inner wall of a vacuum envelope or the like, and there is disclosed a structure formed by piling thin films of getter materials having electric conductivity such as titanium (Ti) or zirconium (Zr) on the metal back layer (for example, see Patent Document 2).

However, there has been a problem that in the phosphor screen having the divided metal back layer a resistance value of the separating portion is hard to control as well as that an end portion of the metal back layer of both sides of the separating portion has a sharp shape so that the electric field concentrates in this acute angle part, easily causing a discharge.

In such an image display unit having the metal back layer in which the separating portion is formed, it has been required, when the layer of the getter material is formed in the image display region, that effect of dividing the metal back layer is not damaged, and that the occurrence of the discharge is restrained so that the withstand voltage property is improved.

The present invention has been made to solve these problems, and its object is to provide an image display unit in which a withstand voltage property is largely enhanced and destruction or deterioration of an electron emission element or a phosphor screen due to an abnormal discharge is prevented so that display of high luminance and high quality is possible.

Patent Document 1: Japanese Patent Laid-open Application No. 2000-311642

Patent Document 2: Japanese Patent Laid-open Application No. Hei 9-82245

### DISCLOSURE OF THE INVENTION

An image display unit of the present invention comprising a face plate; a rear plate disposed facing the face plate; a large number of electron emission elements formed on the rear plate; and a phosphor screen emitting by an electron beam emitted from the electron emission element, the phosphor screen being formed on an inner surface of the face plate, wherein the phosphor screen includes a light absorption layer, a phosphor layer, a metal back layer having a separating portion, the metal back layer being formed on the phosphor layer, a high-resistance covering layer formed on the separating portion of the metal back layer in such a way as to be laid across the metal back layer of both sides of the separating portion, a heat-resistant fine particle layer formed on the high-resistance covering layer, and a getter layer for ed in a film shape above the metal back layer and divided by the heat-resistant fine particle layer.

In this image display unit, the separating portion of the metal back layer can be positioned on the light absorption layer. The high-resistance covering layer can have a surface resistance of from 1×10³ to 1×10¹² Ω/□. An average particle size of the heat-resistant fine particles can be from 5 nm to 30 μm. Further, the heat-resistant fine particle can be a particle of at least one kind of oxide selected from SiO₂, TiO₂, Al₂O₃, and Fe₂O₃. Furthermore, the getter layer can be a layer of a metal selected from Ti, Zr Hf, V, Nb, Ta, W, and Ba, or of an alloy containing at least one kind of these metals as a main constituent

### BRIEF DESCRIPTION OF DRAWINGS

FIG. 1 is a cross-sectional view schematically showing a structure of an FED being an embodiment of an image display unit of the present invention.

FIG. 2 is a cross-sectional view enlargedly showing a structure of a face plate of the FED being the embodiment.

### BEST MODE FOR CARRYING OUT THE INVENTION

Hereinafter an embodiment according to the present invention will be described. It should be noted that the present invention is not limited to the following embodiment.

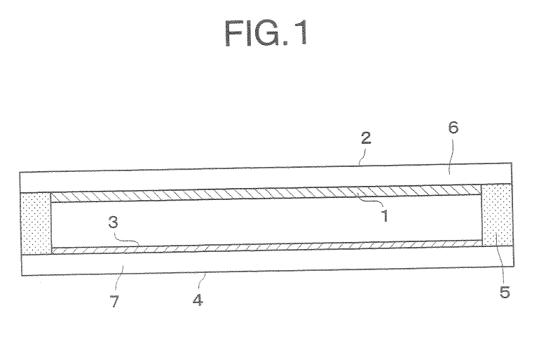

FIG. 1 is a cross-sectional view schematically showing a structure of an FED being a first embodiment of an image display unit according to the present invention.

In this FED, a face plate 2 having a metal-backed phosphor screen 1 and a rear plate 4 having electron emission elements 3 arranged in a matrix such as surface conduction type electron emission elements are disposed facing each other with a gap as narrow as from 1 mm to several mm via a support frame 5 and a spacer (illustration omitted). The face plate 2 and the rear plate 4 are sealed and fixed to the support frame 5 by a joining material such as frit glass (illustration omitted). Accordingly, a vacuum envelope is formed by the face plate 2, the rear plate 4 and the support frame 5, the inside thereof being exhausted and kept in a vacuum. Additionally, it is constructed such that a voltage as high as from 5 to 15 kV is applied in a very narrow gap between the face plate 2 and the rear plate 4. In the drawing, a numeral 6 denotes a glass substrate of the face plate, while a numeral 7 denotes a substrate of the rear plate.

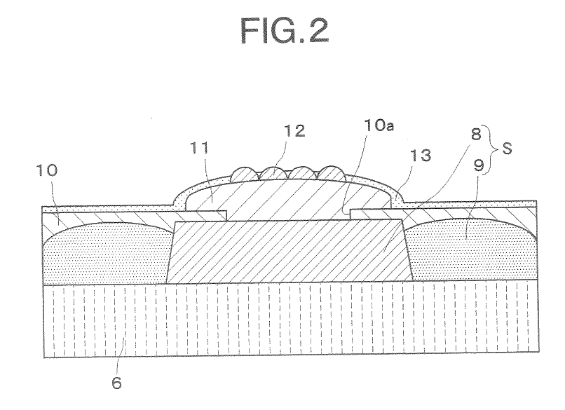

A structure of the face plate 2 having the metal-backed phosphor screen 1 is enlargedly shown in FIG. 2.

As shown in FIG. 2, light absorption layers 8 of predetermined patterns (for example, in stripes) made of a black pigment is forced on an inner surface of the glass substrate 6 by a photolithography method or the like, and phosphor layers 9 of three colors of red (R), green (G), and blue (B) are formed between the patterns of the light absorption layers 8 in predetermined patterns by a slurry method using phosphor liquid such as ZnS-based, Y₂O₃-based, or Y₂O₂S-based phosphor liquid. Accordingly, a phosphor screen S consists of the light absorption layers 8 and the phosphor layers 9 of three colors. The phosphor layers 9 of the respective colors can also be formed by a spray method or a printing method. When the spray method or the printing method is used, patterning by the photolithography method can also be used together.

Additionally, a metal back layer 10 made of a metal film such as an Al film is formed on the phosphor screen S constructed in the above-described manner. To form the metal back layer 10, there can be adopted a method (lacquer method), in which the metal film of the Al film or the like is vacuum-deposited on a thin film made of an organic resin such as nitrocellulose formed by a spin method, for example, and then an organic matter is baked and removed.

It is also possible to form the metal back layer 10 by a transfer method, using a transfer film described below. The transfer film has a construction in which a metal film of Al or the like and an adhesive layer is stuck in sequence with a release agent layer intervened (a protective film, if necessary) on a base film. This transfer film is disposed in a manner that the adhesive layer contacts the phosphor layers and then pressing processing is performed. As pressing methods, a stamp method, a roller method and the like can be cited. By pressing the transfer film while heating it to make the metal film adhere and then stripping the base film, a metal film is transferred on the phosphor screen S.

According to the embodiment of he present invention, for the purpose of enhancing a withstand voltage property, a separating portion 10a is formed in the metal back layer 10, and a gap is provided to the separating portion 10a. In order to obtain a phosphor screen of high luminance, it is desirable that the separating portion 10a of the metal back layer 10 is positioned on the light absorption layer 8.

To form the separating portion 10a in the metal back layer 10, there can be adopted a method of cutting or removing, by radiation of laser or the like, the metal film formed on the entire surface of the phosphor screen by the above-described lacquer method or the transfer method, a method of dissolving and removing, by application of aqueous acid or alkaline solution, the metal layer formed on the entire surface of the phosphor screen in a similar way, or the like. It is also possible to form the metal back layer 10 having the separating portion 10a in one step by depositing a metal film of Al or the like using a metal mask having an opening of a predetermined negative pattern.

On the separating portion 10a of the metal back layer 10, a high-resistance covering layer 11 having high electrical resistance is formed in such a way as to be laid across end portions of the metal back layer 10 of both sides by a method of screen printing, spray application, or the like, and by this high-resistance covering layer 11, the separating portion 10a of the metal back layer 10 is electrically connected at a predetermined resistance value. When a plurality of separating portions 10a of the metal back layer 10 exist, it is desirable that the high-resistance covering layers 11 of high-resistance are formed on all the separating portions 10a.

Here, it is desirable that a surface resistance value of the high-resistance covering layer 11 is from 1×10³ to 1×10¹² Ω/□ (square). When the surface resistance of the high-resistance covering layer 11 is less than 1×10³ Ω/□, electric resistance between divided parts of the metal back layer 10 becomes too low, and effects, namely, restrained discharge and reduced peak value of a discharge current, cannot be achieved sufficiently, and as a consequence, an enhancing effect of the withstand voltage property is not demonstrated sufficiently. When the surface resistance of the high-resistance covering layer 11 is more than 1×10¹² Ω/□, electric connection between the end parts of the divided metal back layer 10 becomes insufficient, which is not preferable in view of the withstand voltage property.

Further, a pattern width of this high-resistance covering layer 11 is to be equal to or more than a width of the separating portion 10a of the metal back layer 10 so that the high-resistance covering layer 11 completely covers the separating portion 10a of the metal back layer 10. At the same time, it is desirable that the pattern width of the high-resistance covering layer 11 is equal to or less than a width of the light absorption layer 8 being a lower layer, in order not to deteriorate light emission efficiency of the phosphor screen.

As a material constituting such a high-resistance covering layer 11, for example, a binder type material containing heat resistant inorganic particles and low-melting glass respectively can be used.

As the low-melting glass, any glass material whose melting point is equal to or below 580° C. and which has binder type property can be used and kinds are not particularly limited. For example, at least one kind selected from glasses represented by a composition formula (SiO₂•B₂O₃•PbO), (B₂O₃•Bi₂O₃), (SiO₂•PbO), or (B₂O₃•PbO) can be used. As the heat-resistant inorganic particles, kinds are not particularly limited, and there can be used carbon particles or at least one kind selected from oxides of metal or the like such as FeO₃, SiO₂, Al₂O₃, TiO₂, MnO₂, In₂O₃, Sb₂O₅, SnO₂, WO₃, NiO, ZnO, ZrO₂, ITO, and ATO. A particle size of the inorganic particle is desirably less than 5 μm so that the high-resistance covering layer 11 can be patterned accurately. Thickness of the high-resistance covering layer 11 including the heat-resistant inorganic particles and the low-melting glass is not particularly limited since the thickness itself does not come to be a factor of a discharge, but is desirably equal to or less than 10 μm.

Further, a weight ratio of the low-melting glass contained in such a high-resistance covering layer 11 relative to the inorganic particles is desirably equal to or more than 50 weight percent. If the weight ratio of the low-melting glass relative to the inorganic particles (low-melting glass/inorganic particles) is less than 50 weight percent, strength of the high-resistance covering layer 11 is not enough and the inorganic particles may fall off, deteriorating the withstand voltage property.

According to the embodiment of the present invention, on the above-described high-resistance covering layer 11, a heat resistant fine particle layer 12 of a predetermined pattern is formed by a method of screen printing or the like, and a getter material is deposited from above the pattern of the heat resistant fine particle layer 12. As a consequence of formation of a deposited film of the getter material only in a region in which the heat resistant fine particle layer 12 is not formed, there is formed above the metal back layer 10 a film-shaped getter layer 13 having a reversed pattern of the pattern of the heat resistant fine particle layer 12. As described above, the film-shaped getter layer 13 divided by the pattern of the heat resistant fine particle layer 12 can be obtained.

As the heat resistant fine particles, any fine particles having insulation performance and also capable of resisting high temperature heating in a sealing step or the like can be used and kinds are not particularly limited. For example, there can be cited fine particles of oxides such as SiO₂, TiO₂, Al₂O₃, Fe₂O₃ and the like, and it is possible to use one kind or more than one kinds combined from these.

An average particle size of these heat resistant fine particles is desirably from 5 nm to 30 μm, and more desirably from 10 nm to 10 μm. When the average particle size of the fine particles is less than 5 nm, unevenness hardly exists on a surface of the heat resistant fine particle layer 12, and when the getter material is deposited from thereabove, the getter film is formed also on the heat resistant fine particle layer 12, making it difficult to form a separating portion on the getter layer 13. When the average particle size of the heat resistant fine particles exceeds 30 μm, forming itself of the heat resistant fine particle layer 12 is impossible.

A region in which the pattern of the heat resistant fine particle layer 12 is formed is on the high-resistance covering layer 11, that is, the region is positioned above the light absorption layer 8, and hence there is an advantage that luminance decrease due to absorption of an electron beam by the heat resistant fine particles is small. It is desirable that a pattern width of the heat resistant fine particle layer 12 is equal to or more than 50 μm, preferably equal to or more than 150 μm and is equal to or less than a width of the light absorption layer 8. When the pattern width of the heat resistant fine particle layer 12 is less than 50 μm, dividing effect of the getter film cannot be achieved sufficiently, and when the pattern width exceeds the width of the light absorption layer 8, the heat resistant fine particle layer 12 reduces the light emission efficiency of the phosphor screen, and hence both cases are not preferable.

As a getter material constituting the getter layer 13, there can be used a metal selected from Ti, Zr, Hf, V, Nb, Ta, W, and Ba, or an alloy containing at least one kind of these metals as a main constituent.

Incidentally, after the getter layer 13 is formed by the deposition of the getter material, the getter layer 13 is constantly kept in a vacuum atmosphere in order to prevent deterioration of the getter material. Accordingly, after the pattern of the heat resistant fine particle layer 12 is formed on the high-resistance covering layer 11, the vacuum envelope is set up so that the phosphor screen is disposed inside the vacuum envelope, and the deposition step of the getter material is performed in the vacuum envelope.

In the embodiment of the present invention, the high-resistance covering layer 11 which has high surface resistance is provided on the separating portion 10a of the metal back layer 10 divided into some blocks to enhance the withstand voltage property, in such a way as to be laid across the metal back layer 10 of both sides, and by this high-resistance covering layer 11 the end parts of the metal back layer 10 are covered. The end part of the divided metal back layer 10 often becomes an electrical protrusion portion, but occurrence of a discharge is restrained since the electrical protrusion portion is completely covered by the high-resistance covering layer 11. Additionally, since the divided metal back layer 10 is connected at a desired resistance value (from 1×10³ to 1×10¹² Ω/□ in surface resistance) via the high-resistance covering layer 11, the withstand voltage property is further enhanced.

Additionally, on such a high-resistance covering layer 11, the pattern of the heat resistant fine particle layer 12 is formed and by this heat resistant fine particle layer 12 the getter layer 13 formed above the metal back layer 10 in the film shape is divided, and hence divided effect of the metal back layer 10 is not impaired, ensuring the good withstand voltage property. Also, by this divided getter layer 13, absorption of discharged gas in the vacuum envelope is performed sufficiently.

Therefore, in a flat surface type image display unit such as an FED, occurrence of a discharge is restrained and a peak value of a discharge current can be kept at a low level. As a result of reduction of the maximum value of discharged energy, destruction, damage or deterioration of the electron emission element or the phosphor screen can be prevented. In the FED of the embodiment, since the separating portion 10a of the metal back layer 10 is limited to the region corresponding to the light absorption layer 8 and thereon the high-resistance covering layer 11 and the heat resistant fine particle layer 12 are provided, reflection effect of the metal back layer 10 is hardly reduced. Additionally, decrease of light emission efficiency due to formation of the high-resistance covering layer 11 and the heat resistant fine particle layer 12 does not occur, allowing display of high luminance.

Next, specific examples in which the present invention is applied to an image display unit will be described.

### EXAMPLE

After light absorption layers in stripes (100 μm in pattern width) made of a black pigment was formed on a glass substrate by a photolithography method, phosphor layers of three colors of red (R), green (G), and blue (B) were formed on the light absorption layers by a slurry method and patterned by the photolithography method. Accordingly, there was formed a phosphor screen in which the phosphor layers of three colors in stripes were arranged in sequence between the light absorption layers.

Subsequently, a metal back layer was formed on this phosphor screen by a transfer method. That is, an Al transfer film in which an Al film was stacked on a base film of a polyester resin via a release agent layer, and thereon an adhesive layer was applied/formed, was prepared. The Al transfer film was disposed in a manner that the adhesive layer contacted the phosphor screen, and the film was heated/pressed from above by a heating roller, to be attached closely. Next, after the base film was peeled off and the Al film was adhered on the phosphor screen, the Al film was pressed. As described above, a substrate (A) having the phosphor screen on which the metal back layer was transferred was obtained.

Next, while this substrate (A) was kept in a temperature of 50° C., acid paste (equal to or less than pH 5.5) containing phosphoric acid, oxalic acid or the like was applied on the Al film using a metal mask having openings at positions corresponding to above the light absorption layers, and then baking was performed at 450° C. for 10 minutes. By the application of the acid paste and the baking, the applied part of the Al film was solved so that separating portions (80 μm in width) in stripes were formed in the metal back layer made of the Al film. As described above, a substrate (B) having the divided metal back layer was formed.

After a high-resistance paste having the following composition was screen printed on the separating portion of the metal back layer of the substrate (B), heating and baking was performed at 450° C. for 30 minutes to decompose/remove organic matter and a high-resistance covering layer with a pattern width of 90 μm and a thickness of 5.0 μm was formed in a way as to be laid across both sides of the separating portion of the metal back layer. A surface resistance value of this high-resistance covering layer was measured to be 1×10⁹ Ω/□. A substrate (C) in which the high-resistance covering layer was formed on the separating portion of the metal back layer was obtained.

[Composition of high-resistance paste]

| | |
|---|---|
| carbon particle (50 nm in particle size) | 20 wt % |
| low-melting glass material (SiO₂•B₂O₃•PbO) | 10 wt % |
| resin (ethyl cellulose) | 7 wt % |
| solvent (butylcarbitol acetate) | 63 wt % |

Subsequently, silica pate having the following composition was screen printed on the high-resistance covering layer of the substrate (C) so that a silica particle layer with a pattern width of 100 μm and a thickness of 7.0 μm was formed. A substrate (D) in which the silica particle layer was formed on the high-resistance covering layer was obtained.

[Composition of silica paste]

| | |
|---|---|
| silica particles (3.0 μm in particle size) | 40 wt % |
| resin (ethyl cellulose) | 6 Wt % |
| solvent (butylcarbitol acetate) | 54 wt % |

Next, the substrate (D) was used as a face plate and an FED was fabricated by an ordinary manner. First, an electron emission source on which a large number of electron emission elements were formed on the substrate was fixed to a rear glass substrate, so that a rear plate was fabricated. Subsequently, with the substrate (D) being the face plate, the face plate and the rear plate were disposed facing each other via support frames and spacers, to be fixed and sealed by a frit glass. A gap between the face plate and the rear plate was 2 mm.

Next, after an envelope which was formed by the face plate, the rear plate and the support frames was evacuated, Ba was evaporated toward an inner surface of the face plate so that Ba was deposited on the silica particle layer As a result, on the silica particle layer, Ba being a getter material was accumulated but a uniform film was not formed, while a uniform deposition film of Ba was formed on a region above the metal back layer on which the silica particle layer was not formed. Accordingly, there was formed a Ba getter layer in a film shape which was divided by the silica particle layer. Then, necessary processing such as sealing or the like was performed and an FED was attained.

As a comparative example 1, using a substrate (B) having a divided metal back layer as a face plate, an FED was fabricated by an ordinary manner as in the example. In a comparative example 2, using as a face plate a substrate (C) in which a high-resistance covering layer was formed on a separating portion of the metal back layer, an FED was fabricated by an ordinary manner as in the example. Further, in a comparative example 3, a high-resistance covering layer was not formed and a silica particle layer was directly formed on a separating portion of a substrate (B) having a divided metal back layer, and using this substrate as a face plate, an FED was fabricated.

A withstand voltage property (discharge voltage and discharge current) of each FED obtained in the example and the comparative examples 1 to 3 was measured by an ordinary manner. The measured result is shown in Table 1.

TABLE 1

| | | | Com- | Com- | |
|---|---|---|---|---|---|
| | | | parative | parative | Comparative |
| | | Example | Example 1 | Example 2 | Example 3 |
| Presence/Absence of | | Present | Absent | Present | Absent |
| High-resistance | | | | | |
| Covering Layer | | | | | |
| Presence/Absence of | | Present | Absent | Absent | Present |
| Silica Particle | | | | | |
| Layer | | | | | |
| Withstand | Discharge | 12 kV | 2 kV | 5 kV | 6 kV |
| Voltage | Voltage | | | | |
| Property | Discharge | 1 A | 120 A | 120 A | 50 A |
| | Current | | | | |

As is obvious from Table 1, it is found that since in the FED obtained in the example, the high-resistance covering layer is formed on the separating portion of the metal back layer and on the high-resistance covering layer the silica particle layer is further formed to divide the Ba getter film, the discharge voltage is remarkably enhanced and the discharge current value is considerably restrained, compared with the FEDs in the comparative examples 1 to 3 which do not have such structures.

### INDUSTRIAL APPLICABILITY

As described above, according to the present invention, a withstand voltage property is considerably enhanced, an image display unit in which destruction or deterioration of an electron emission element or a phosphor screen due to an abnormal discharge is prevented can be obtained, and display of high luminance and high quality can be realized.

What is claimed is:

1. An image display unit, comprising:
a face plate;
a rear plate disposed facing the face plate;
a large number of electron emission elements formed on the rear plate; and
a phosphor screen emitting by an electron beam emitted from the electron emission element, the phosphor screen being formed on an inner surface of the face plate,
wherein the phosphor screen includes a light absorption layer, a phosphor layer, a metal back layer having a separating portion, the metal back layer being formed on the phosphor layer, a high-resistance covering layer formed on the separating portion of the metal back layer in such a way as to be laid across the metal back layer of both sides of the separating portion, a heat-resistant fine particle layer formed on the high-resistance covering layer, and a getter layer formed in a film shape above the metal back layer and divided by the heat-resistant fine particle layer.

2. The image display unit as set forth in claim 1, wherein the separating portion of the metal back layer is positioned on the light absorption layer.

3. The image display unit as set forth in claim 1 or claim 2, wherein the high-resistance covering layer has a surface resistance of from 1×10³ to 1×10¹² Ω/□.

4. The image display unit as set forth in claim 1, wherein an average particle size of the heat-resistant fine particles is from 5 nm to 30 μm.

5. The image display unit as set forth in claim 1, wherein the heat-resistant fine particle is a particle of at least one kind of oxide selected from SiO₂, TiO₂, Al₂O₃, and Fe₂O₃.

6. The image display unit as set forth in claim 1, wherein the getter layer is a layer of a metal selected from Ti, Zr, Hf, V, Nb, Ta, W, and Ba, or of an alloy containing at least one kind of these metals as a main constituent.
